(19) United States
(12) Patent Application Publication
(10) Pub. No.: US 2017/0085635 A1
(43) Pub. Date: Mar. 23, 2017

(54) SYSTEM AND METHOD OF MANAGING SERVERS FOR STREAMING DESKTOP APPLICATIONS

(71) Applicant: MEDIA SPEED TECH, LLC A DELAWARE LIMITED LIABILITY COMPANY, Sarasota, FL (US)

(72) Inventor: JASON FREDRICK NICHOLLS, Willow Acres (ZA)

(73) Assignee: EVOLOGY LLC, A FLORIDA LIMITED LIABILITY COMPANY, Sarasota, FL (US)

(21) Appl. No.: 14/862,633

(22) Filed: Sep. 23, 2015

(51) Int. Cl. H04L 29/08; H04L 29/06; H04L 12/24

(52) U.S. Cl. CPC H04L 67/1008; H04L 41/12; H04L 67/42

(57) ABSTRACT

A system for client devices to access server based application where a management server sends to a client device receives from a management server a set of worker-servers. The client then sends one or more messages to the set of worker servers which are configured to send one or more a long response messages. The time to receive a response messages it timed by the client device and a worker-server for each of the one or more ping message is time for each server in the set. Further, the variance in sending the messages can be generated. A worker server is selected based on the shortest response times and the variance if the responses can be provide a threshold for selecting a worker-server.

### CROSS REFERENCE TO OTHER APPLICATIONS

This is application claims priority to co-pending U.S. patent application Ser. No. 13/533,898 filed on Jun. 26, 2012 entitled “SYSTEM AND METHOD OF MANAGING SERVERS FOR STREAMING DESK TOP APPLICATIONS”, the content of which is relied upon and incorporated herein by reference in its entirety, which claims priority to application entitled “SYSTEM METHOD DEVICE FOR STREAMING VIDEO” Ser. No. 13/471,546 filed May 15, 2012 which claims priority under 35 U.S.C. §119(e) to U.S. provisional patent application Ser. No. 61/685,736 filed on Mar. 21, 2012. The application entitled “SYSTEM METHOD DEVICE FOR STREAMING VIDEO” Ser. No. 13/471,546 filed May 15, 2012 and U.S. provisional patent application Ser. No. 61/685,736 filed on Mar. 21, 2012, and titled “DEVICE SYSTEM METHOD FOR STREAMING VIDEO” are incorporated by reference in their entirety.

### FIELD OF THE INVENTION

This invention relates to new and novel systems and methods of selecting and allocating server cluster/farm resources for server execution of a desktop application. The desktop applications have high graphics processing requirements and stream server-application generated graphics and other multi-media content to a global network connected client device and manage client device and application specific persistence data for execution between different servers.

### BACKGROUND

A server located at one or more server cluster locations can be configured with an operating execution environment where a desktop application, normally operating on a single integrated computer, executes in a client server system model. However, this client server architecture causes several issues. First, one reason to use a high-performance server executing the applications is for the server to operate as a shared resource and as a resource that is available from a pool of servers. As a shared resource an expensive resource can be shared by a number of users thus providing a cost savings to a number of people. The issue of sharing, managing, and allocating servers needs to be addressed by new and novel techniques.

One issue that has to be addressed in a client server model is the handling of application-persistent data when different servers can be utilized at different times. Exemplar of this issue is a gaming application that stores locally user specific application state information regarding a game player's state in the game. When the server is used as a shared resource, the application will save application-persistent data locally. After pausing or ending the application, the server within a server cluster is free as a resource for other users. However, the returning user or game player may expect to be able to resume the application/game from where it was ended. The new allocated server, to which the client device connects, needs this prior application-persistent data to resume execution at the point where the application had left off.

Other issues in managing a client-server model include managing a pool of servers for a large number of users and applications. Some applications, such as games, have different computer resource requirements. Some games require or perform better with higher performance graphics cards while other applications operate well with a slower CPU (central processing unit), less memory requirement and lower performance graphics card. Thus, not all of the servers require all the same performance requirements. However, current servers within a cluster typically have uniform resources between the servers. Having to have a high-performance server for each user regardless of the application processing needs is a waste of processing resources, requires extra power, and increases costs for a user. Prior art resource allocation methods for servers are not based on a server's computational resources but load.

Another issue is the servers and server clusters can be distributed between different data centers and access through networks with different delay characteristics. The transmission delay between a server and client computer can vary between each data center. Further, traditional methods of transmission delay between a server and the client device uses a small packet to measure the transmission delay. However, this method can inaccurately measure the delay for large a high bandwidth streams of data.

What is needed is a system where application persistence data is available to different servers to resume an application executing in a client-server mode; a method of server selection with minimum transmission latency between the server and client for a high bandwidth transmission environment; a method for server selection that meets the minimum computational resources needed for the application; and a method for selection a server that has a selected application to run or resume.

### BRIEF DESCRIPTION OF THE DRAWINGS

FIG. 1 is a block diagram of the architecture of a system for selecting worker-servers and streaming multi-media data generated by an application executing on the server.

FIG. 2 is a block diagram of a method for selecting a worker-server and streaming multi-media to a client device.

FIG. 3 is a diagram of one embodiment of a data structure for holding worker server information.

FIG. 4 is a diagram of one embodiment of a data structure for client device information.

FIG. 5 is a diagram of one embodiment of minimum application resource requirements.

### SUMMARY OF THE INVENTION

In one aspect of the invention, a system is provided that selects a worker-server which streams real-time multi-media content from a selected-worker-server to a network attached client-device where a desk top application executing on a selected-worker-server. The system consists of a plurality of worker-servers, a management-server, a client device, and a database-server. The management-server, the worker-servers, and the client-device, and database-server can communicate over a global of private network.

A management server sends a first-set of worker-server identifiers from the plurality of worker-server identifiers to the client device. A worker-server-identifier is uniquely associated with a worker server. The number of worker-server identifiers preferably varies from one to ten. Each worker-server identifier is associated with a worker-server and a network address for communication. The number of worker-server identifiers should be limited or selecting a worker server will take too long. Preferably, some of the first-set worker servers are at a different physical location.

The selection of a worker server can be based on transmission latency between the client device and the worker server, the variance in transmission time, the computational resources required by an application to be executed within a server, whether the worker server is occupied running another application, or a combination thereof. The geographic distance between the client and server can function as a proxy for the transmission latency between the worker server and client device. Further the management server is configured to communicate through the global network and can receive a client identifier and application identifier sent by the client-device.

Each worker-server is running a desktop compatible operating system and is coupled to a global network. The operating system can be configured to take the generated multi-media content, including the rendered display graphics, and audio, generated by the desk top application, and transmit the multi-media content to the client device over the global network. Further, each worker-server is configured to receive user inputs from the client-device and input these into the desktop application in a manner that appears like a user is working directly on a desktop computer system. Further details of the methods and devices for streaming the real-time application generated multimedia and user inputs can be found in the incorporated application Ser. No. 13/471,546 entitled “SYSTEM METHOD DEVICE FOR STREAMING VIDEO” filed May 15, 2012. The application discloses a method of scraping screens of graphic renderings, compressing the rendered frame data, and sending it over the network to a client-device.

Additionally, the worker-server stores in and loads from a database-server 400 application-persistent data when the application is started or ended. The application persistent database 410 can be a separate server or a database on the management server. The management server, when starting an application, based on a client identifier and application identifier will load the application persistent data into the worker server operating system.

The applications can be compatible with the Microsoft Windows® desktop operating system and the application—persistent data can include registry variables, environment variables, and data files. Thus, a user of a client device application can start and stop the application and resumed at the same point on a different worker server. However, the application will resume where the user last left off and behave as if restarting on the same desktop computer system.

The system includes a database server in communication with the management server and the worker servers. The communication can be over a global public, private, or cellular network, including the Internet. The database stores both client information and server information. Client information can include but is not limited to the client device geo-location data, the applications that have been executed, the application-persistent data, and what applications are allowed to execute on the client device. The worker server information can include but is not limited to geo-location of the worker server and the computational resources of the server. The worker server computational resources can include CPU (central processing unit) type, CPU clock speed, number of graphic processors, amount of graphic processing memory, and the amount of random access memory available to the CPU.

The desktop operating system can includes but is not limited to Microsoft Windows desktop operating system. This operating system includes Windows XP®, Window Vista®, Windows 7®, Windows 8®, and Windows Server. The application-persistent data can include but is not limited to Windows registry variables, application files, and environment variables that are loaded from the database for previously run applications and are saved when an application is exited. Further the database can include data files that are loaded into the worker server data structures and made available to the client device, and to the application.

In another aspect of the invention, a method of allocating worker servers and streaming the application generated multimedia output to a client device is described. A client device communicates to a management server an application-identifier and a client-identifier. The communications is over a global network that can include but is not limited to the Internet. The application identifier indicates an application that is to be run on a worker-server and can be used to select the worker-server that has computational resources sufficient for the identified application. The client-identifier and application-identifier are used to identify if there is application-persistent data stored from a previous execution of the client requested application. Further, the client device is configured to receive multimedia data generated by the application executing on the worker server.

In a further step, the management server selects a first-set of worker-server identifiers and sends the them to the client device. The first-set of worker-servers can be based on one or more parameters. These parameters include but are not limited to geographic location, the number of graphics processing cores, whether the worker-server is running an application using the graphics processing hardware, or a combination thereof. Additionally, all worker-servers in the first-set include high-performance graphics processing hardware.

In a step, the client-device sends one or more broadband-ping messages to each of the worker-servers identified in the first-set of worker-servers. The messages can include the size of the broadband-echo data stream. Preferably, the number of broadband-ping messages is between one and ten. Preferably, the number of worker-server in the first-set is between 2-10. Preferably, at least one of the worker-services are at geographically different locations. It is expected that that network transmission time will not vary much for servers at that same location but they can vary.

The client-device receives an associated broadband-echo data stream for each of the one or more broadband-ping message sent to each of the first-set of worker-servers. The size of the broad-band-echo data stream can vary from ten kbytes to one mega-byte.

The client-device records the time-intervals between sending each of the one or more broadband-ping message and receiving each of the one or more associated broadband-echo data streams for each of the first-set worker-servers. Further, the client device can compute the variance for the time-intervals associated with each first-set or worker servers.

The worker-server is selected from the first-set of worker server. The selection can be the worker-server with the lowest cumulative time-intervals, the worker-server with the lowest cumulative time-intervals with a variance below a threshold, the worker-server with computational resources with the minimum computational requirements of the client requested application, or a combination thereof.

The client device then sends to the selected-worker-server the client-identifier and the application-identifier and an indication to start the associated application, the selected-worker-server request from and receives from the database server, application-persistent data associated with the client-identifier and application-identifier. The application persistent data is loaded into the selected-worker-server operating system. This can include Windows desktop operating systems including Microsoft Windows XP®, Window Vista®, Windows 7®, Windows 8®, and Windows Server. The application persistent data can include but is not limited environment variables, registry variables, and program files. Note that the operating system on the client-device can differ from the worker-server operating system.

The selected-worker-server starts the execution of the application associated with the application-identifier when the user is done when the user is done using the application.

The client-device sends to the selected worker server an indication that the application should stop running. The selected-worker server will send to the database server the updated application persistent data. This data is stored by the database server to for the next time a user associated with the client-identifier starts the application.

In another step a desktop operating system is loaded on the selected worker server and executed. The operating system is modified such that the executing application generated multimedia output including but not limited to rendered video graphics frames from the high performance graphics hardware and audio are compressed streamed to the client device. The operating system is further modified such that client device user inputs are streamed to the worker server and input into the operating system in a manner that appears as from a user directly connected to the worker server.

### DETAILED DESCRIPTION OF THE INVENTION

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

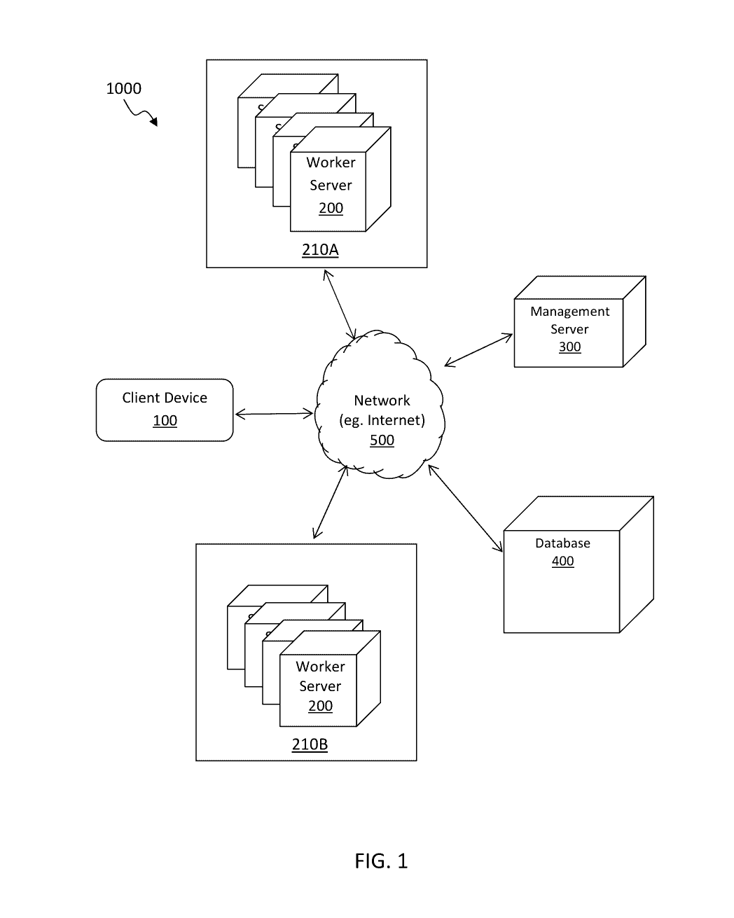

FIG. 1 is exemplar of a system 1000 for allocating worker-servers 200 to execute a desk-top-application and stream the graphics and multimedia content generated by the application to a client-device 100 over a global network 500. The system is comprised of groups of worker-servers 200 that can be geographically distributed and coupled by a global network 500. The groups of worker-servers 200 can be housed in one or more data centers 210A, 210B. The client-device 100 and worker-servers 200 communicates with a management-server 300 which allocates a worker server 200 to run a client-device 100 requested application. A database 400 is in communication with the worker-servers 200, client-device 100 and the management server 300 for saving client-device 100 and application associated application-persistent data, and for holding information that is sent to the client device for selecting a worker-server 200.

The client device 100 includes computer devices with one or more input/output interfaces. The user interfaces can include but are not limited to rendered video frames, audio output, audio input, keyboard inputs, and mouse inputs. Types of client-devices include personal computers, laptops, personal digital assistants, smart phones, and tablet computer devices. The relevant characteristic of the client device is a lack of high performance graphics processing capability.

A very significant relationship between the client device 100 and a worker server 200 is that the computational power required to decode a compressed video frame is significantly less than the computational requirement to render graphic frames from a video game. Whereas the computational requirements for increasing a gaming model's complexity, then number of elements, detail, and shading grow geometrically as games become more realistic, the computational requirement for decoding a rendered and compressed video frame is virtually constant. Thus, a given client device can support receiving and displaying compressed rendered graphic frames independent from the graphic rendering complexity.

Another significant distinction is the operating system on the client device does not have to be the same as the operating system running on the worker-server. Normally when playing a game, the OS display the game is the same as the one executing the game. The client-device, being able to display the scraped graphics renderings can be executing under a different operating system and therefore providing a greater flexibility to users on the device they can use.

The worker-server 200 can be any computer server that can run a desired desktop application and is configured with high performance graphics processing capability. For the purpose of this invention, “high performance graphics hardware” is defined as a server having graphics processing electronics with thirty-two (32) or more graphics processing cores that can process graphics data substantially in parallel. The worker-server can be a standalone device or preferably a server blade in a data center 210A, 210B. Preferably the worker-server 200 is running a desktop operating system. Exemplar of such an operating system is a server running a Microsoft Windows desktop operating system such as Microsoft Windows XP®, Windows Vista®, Windows 7®, Windows 8®, Windows 10®, and Windows Server®.

Another significant limitation of the worker-server 200 is that only one application that utilizes most of the high performance graphics hardware runs on the worker-server at one time. Because of limitations with the graphics card, only one application can utilize the graphics card. This differs from servers configured with virtual machines operating systems such as VMware® that enable multiple virtual machines running on a single server or processor.

The operating system of the worker-server 200 is modified to support streaming of the multimedia content including but not limited to compressed rendered graphics and audio, generated by a desktop application running on the server's desktop operating system. Streaming can be to a client-device connected to the worker-server over a global network. One method and system embodiment by which this streaming is performed and by which the operating system is modified to perform this task is provided in the application “SYSTEM METHOD DEVICE FOR STREAMING VIDEO” Ser. No. 13/471,546 filed May 15, 2012 which is incorporated by reference.

The management server 300 keep track of which worker-servers are available for connecting with a client-device 100 and which are already connected already connected with a client device. The management server 300 selects a first-set of one or more candidate worker servers that may provide the fastest response, i.e. the lowest network transmission delay. Given that network congestion may be difficult to predict, preferably the management server 300 chooses a least one worker server located at a different geographic location than to other worker-servers in the first-set. The issue with selecting a worker-server is that one cannot rely on what has traditionally been called a ping message. A ping message is small and does not accurately reflect the network delay when transmitting a long continuous stream of high bandwidth data. The delay for a short one packet message can be different than the delay for a large stream of data.

The client-device 100 is configured to send to the management server 300 a client-identifier and an application-identifier. The management server 300 selects a set of worker-servers to be vetted by the client device 100 and sends a first-set of worker server identifiers. The client device is configured to send one of more broadband-ping message to each worker-server identified in the first set which in response causes the respective worker-server to send a broadband-echo response messages. The client device determines the time it takes to send the broadband ping message and receive the broadband-echo data stream. Further, the client device can calculate the variances in the responses from each of the first-set of worker servers. The client chooses the worker-server based on the lowest broadband streaming delay and other parameters. These other parameters can include the variance in transmission and response times. In one embodiment, if a worker server has too great of a variance, then another worker-server is selected.

One method for determining which worker-server has the least network delay for transmitting large amounts of data is to have the worker-server send large streams of data in response to a broadband-ping message. Further, this request can be requested multiple times and invoked causing different sized data streams to be sent. Responses from tens of kilobytes to a megabyte are contemplated. The broadband pings are sent multiple times to more accurately determine the network delay.

Based on the cumulative network delay between the client-device and the set of one or more worker-servers the client-device selects the worker server that will have the best performance. The selected worker-server is reported back to the management server and then flagged as busy with the associated client device identifier.

The management server 300 can select the set of worker servers 200 based on a number of parameters. First, the management server 300 keeps track of which worker servers are running applications for other client-devices. The worker server 200 tracking can include but is not limited to the use of a database 400, a flat file, data file, or a combination thereof. A list of free servers are generated for server selection or as a list for selection based on other server selection parameters.

When the management server 300 has identified a set of free servers, it can further make a server selection decision based on geographical differences. The worker servers 200 can be located in different data centers 210A, 210B which can be located on different sides of the country. These geographical differences are between the worker servers and the client devices 100 result in greater transmission latency. Lower transmission latency is important for real-time applications. Thus, if a closer worker server 200 is selected as part of the server set, then the lower the delay in interacting with the worker server 200 executing application and better real-time performance. However, network congestion can make a server farther away more responsive and thus a variety geographically located server may be selected.

Another parameter that the management server 300 can use in selecting a worker server 200 is the computational resources of the worker server 200 and a minimum-computational resource of the client requested application. All applications do not require the same computational power to properly execute. Some game applications can require more graphics processing where other less graphically intensive applications can need less computational power. Thus, to save cost and power utilization not all of the worker servers 200 need to be configured with maximum computational resources. Different worker servers 200 can have different computational processing capabilities. The management server 300 can then use as selection criteria a server with at least the minimum computational resources required by the client requested application 205. Further, the selected worker server 200 can be the server with the closest computational resources as required by the application 205. These computational resources can include the CPU (central processing unit) speed, number of CPU cores, CPU ram, and graphic card characteristics including but not limited to the number of graphics processors, and graphic processor memory. The worker server selection can be made by generating a list of all servers meeting the minimum application computational requirement or from a worker server list limited by other server selection parameters.

Another worker server 200 selection criteria can be the applications available for the worker server 200 to execute. Due to licensing restrictions, each data center 210 may only have a limited number of licenses to execute for each application. Thus, if all the licenses are in use at one data center 210A, then the management server 300 will have to choose a different data center 210B with available applications for executing the application. The worker server 200 selection can be made by generating a list of all servers having the applications available for execution or from a worker server list limited by other server selection parameters.

The management server 300 can be separate server, a blade in a data center 210A, 2108, or run as a process on one of the worker servers 200. The management server 300 has a known network address so that the client 100 can connect and make request to run an application 205.

The database 400 is shown as a separate component of the system 1000. However, the database can be a database server 400 or can be an application running on the management server 300. The database 400 is in communication with both the management server 200 and with each worker server 200.

The database 400 stores information relating to the client device 100, the application 205, and each worker server 200. For each worker server 200, the database can store information of whether the worker server 200 is in use and by which client 100 and for which application 205. The database can store information about the computational resources of each worker server 200. This can include the CPU (central processing unit) speed, number of CPU cores, CPU ram, and graphic card characteristics such and number of graphics processors, and graphic processor memory.

The network 500 is comprised of packet network, cellular and telephone networks, and access equipment including but not limited to wireless routers and hubs. The packet network includes but is not limited to public networks such as the Internet but can include other public and private networks. Preferably the packet network is the Internet running standard protocols including but not limited to TCP, UDP, and IP. However, the cellular network which can couple with the packet network that can include cellular 3G and 4G networks, satellite networks, cable networks, associated optical fiber networks and protocols, or any combination of these networks and protocols required to transport the multimedia-data from the worker server 200 to the client device 100.

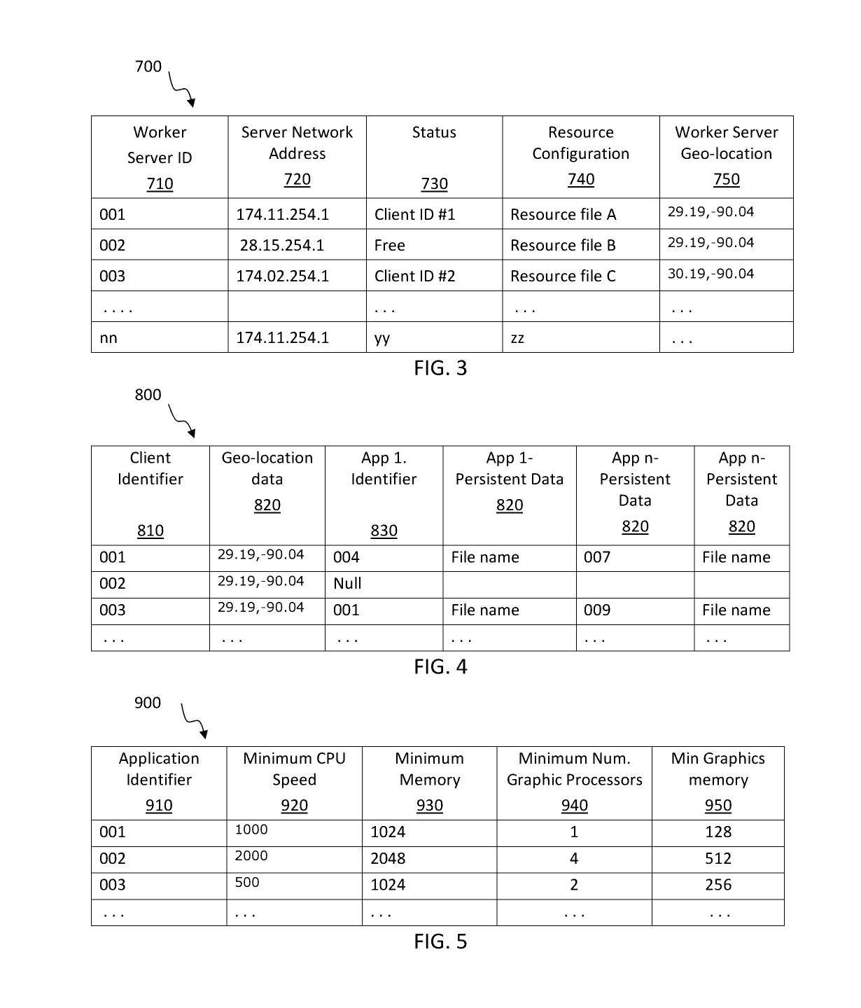

Referring to FIG. 3, a data structure 700 shows one embodiment of data associated with each worker server. The data structure can be stored in a database or in a file. Each worker-server identifier 710 is unique. Associated with each worker server identifier 710 can be a server network address 720, a status 720, a resource configuration 740, and an optional worker server geo-location 750 information.

The server network address 720 provides a network address to connect with the worker server. Preferably, the address is an IP (Internet Protocol) address and can be an IP address that is managed dynamically. The status 730 indicates whether a worker server is free for allocation. When being used to run an application for a client, a client identifier of that client is stored in the database and associated with the worker server ID 710. Also associated with the worker-server identifier 710 is a resource configuration 740. The resource configuration 740 can be a file name or data of the server computational resources. The file name would contain a description of the associated worker server ID 710 computational resources. Optionally, the data structure can include Worker Server Geo-Location data 750. This data can include is preferably in stored in GPS coordinates other coordinated systems are contemplated including longitude and latitude.

Referring to FIG. 4, a data structure 800 shows one embodiment of data associated with each client device. The data structure can be stored in a database or in a file. Each client identifier 810 is unique. Associated with each client identifier 810 is an optional geo-location data 820, No. 1 application identifier 830, and application persistent data 820 associated with No. 1, No. 2 application identifier 830, and application persistent data 840 associated with the No. 2 application identifier 830. More application identifiers and application persistent data can be associated with the client identifier.

Referring to FIG. 5, a data structure 900 shows one embodiment of data associated with each application identifier 910. The data structure can be stored in a database or in a file. Each application identifier 910 is unique. Associated with each application identifier 910 are minimum computational resources needed for the application to execute properly. The computational resources can included but is not limited to minimum CPU processor speed 920, minimum CPU RAM 930, minimum number graphics processors 940, and minimum graphics memory 950.

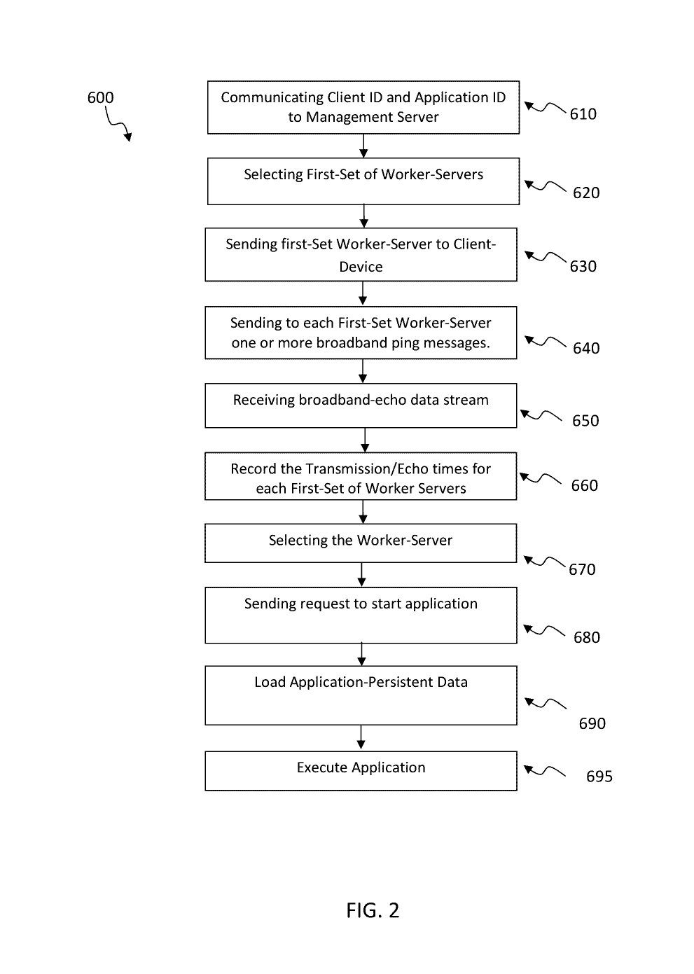

Referring to FIG. 2, another embodiment is shown. A process diagram 600 of selecting a worker server to execute a desk top application and stream the multimedia output of the application to a client device is shown and described. Some of the steps described are optional.

In a step 610, the process begins. A client-device communicates a client-identifier, and an application-identifier to a management server. The client-identifier uniquely identifies a user who may move to a different client device. The application-identifier uniquely identifies a requested application to be executed by the worker server.

Optionally, geo-location tag is sent by the client device. This geo-location information can be user programmed into the client, obtained by a client device associated electronics including but not limited to global positioning electronics or wireless communication triangulation. The communications between the client and the management server can be through a global, public, or private network.

In a step 620, a first-set of worker-servers identifiers not being used by other client-devices is determined by a management server. The tracking of which worker servers are in use can include a database but other methods are contemplated including an internal program data structure and storing the information in a flat file. Further, other characteristics of worker-servers can be used in selecting the first-set of worker servers. These characteristics can include the geographic distance between the client-device and the worker-server, availability of application or licenses.

In a step 630, the management server sends the first-set of worker server identifiers to the client device. The transmission is over a global network. Each worker server can have different computational resources. Each client requested application can have a different minimum computational resource needed for executions. The computational resources can include CPU speed, number of CPU cores, CPU RAM, number of graphic processors and graphic processing memory. However, all worker-servers have high-performance praphic processing hardware.

In a step 640, the client device sends each worker-server identified in the first-set worker-server identifiers one or more broadband ping messages. The broadband pings can be sent sequentially to a worker-server in the first-set of worker-servers before moving on to the next worker-server. Alternatively, the one or more broadband ping messages can be sent round-robin sequencing through the worker-servers in the first-set. Further, the broadband-ping messages can include the size of the associated broadband-echo data stream.

In a step 650, the client-device receives the broadband-echo data streams from each worker server that received the broadband ping message. These should be a received broadband-echo data stream for each of the worker-servers in the first-set of worker-server identifiers and for each of the one or more broadband-ping messages sent to the first-set of worker-server identifiers. Depending on the size of the broadband-echo data stream and the timing of the broadband-ping message, the responses could overlap. For better determination of the round-trip transmission time to and from a worker-server, the timing of the broadband-ping message should be timed to prevent overlap between different worker-servers.

In a step 660, the round-trip transmission times for a broadband-ping and broadband-echo data stream for each worker-server pinged is determined. The transmission times for each of the first-set of worker-servers is accumulated for each of the one or more broadband-pings. Further, the variance in the time to receive a broadband-echo can be measured. In gaming, the user experience is degraded if some of the frame data has excessive delay, causing jerks or pauses in a dynamic game.

In a step 670, a selected-worker-server is determined. The worker-server from the first-set of worker-servers with the lowest cumulative transmission times can be selected. Further, the variance of in the broadband transmission time can be incorporated into the worker server selection process. A worker-server having the lowest broadband transmission delay may not be selected if the associated variance is too high. The worker-server with the next lowest broadband transmission time but with a better variance may be selected. Preferably, the variance broadband transmission times is less than 20% of the average transmission time.

In a step 680, a request is sent by the client to the selected-worker-server to start the application associated with the application-identifier. A client-identifier is also provided for the selected-worker-server to request any needed application persistent data.

In a step 690, application-persistent data associated with the client and client-identifiers is loaded into the selected-worker-server operating system and or the application. When an application is stopped and restarted, it may restart on a different worker-server or on a different client-device. For the application to be able to resume at the same point and in the same configuration, the application-persistent data needs to be available, and loaded into the operating system. For Microsoft Windows desktop application, the application-persistent data can include Windows registry variable, environment variables, state files, data files, or a combination thereof. The management server keeps in the database an association between the client identifier, an application identifier and the application-persistent data. Upon the management server selecting a worker server, the application-persistent data is loaded into the worker server operating system and environment.

In a step 695, the application is executed on the selected-worker-server. The selected-worker-server operating system is configured to stream the multi-media content generated by the application to the client device.

### Operational Example

In one embodiment of the invention, the system operates as described below. In operation, first a connection between a client device and a management-server is set up. The connection is setup by the client device connecting, using a known URL (uniform resource locator) management server over a network that can include the Internet. The management server URL provides the Internet facing URL to which all clients first connect. The management server receives a client-identifier, an application-identifier and optionally a client geo-location tag which can be used to determine which worker server is the closest and thus presumable has the shortest transmission delay.

The client device can provide login information. The management server will either uses a local database or a network coupled database of client information to determine the applications to which the client has access.

A menu of available applications is sent to the client device for user selection. A client agent, a thread or process, on the management server manages the menu. Upon user selection, the client device sends the management server the client identifier, application identifier, and optional geo-location data.

The management server then selects a first-set of worker-servers available to execute the application. The management server determines the worker-servers that are not in use.

Next the management server sends to the client-device a first-set of worker-servers. The client device sends to each worker-server identified in the first-set of worker servers one or more broadband-ping messages. The messages can contain an indication of the number of bytes that the broadband-echo data stream should send back. Preferably, if multiple broadband-ping messages are sent, they are sent immediately after receiving the associated broadband-echo data stream. This will provide a more accurate measure of delay through the network path when loaded with a constant broadband stream of data.

For each first-set worker-server, each broadband-ping and response, the transmission time-interval is measured and accumulated and a variance calculated. The lowest accumulation within a variance range is used to select the worker-server. Preferably, the variance is below 20%. If a pinged worker-server has a variance above this amount, in one embodiment, another pinged worker-server is selected by the client-device.

Alternatively, the distance between the client device and each worker server can be a proxy to a measured transmission. A geo-location for each worker server is read from a file or a database. The client device's geo-location is either provided by the client or has previously been stored in a data base. A distance between each worker server or the worker servers meeting the availability and computational resource requirements are determined.

Next the client-device sends to the selected-worker-server an application-identifier and client-identifier and an indication to start the associated application. The selected-worker-server will request from a database server application-persistent data associated with the client-identifier and application-identifier. Note, the client-identifier is different from the client-device. A user may want to continue a game from the same point on a different device.

The application is next executed. Rendered graphic data is scraped from the graphics memory, compressed, and sent to the client device. When a user is finished with the application and provides an indication of ending the game, the current application persistent data is sent to the database server with the application identifier and client-identifier.

What is claimed is:

1. A system for client devices to access server based applications comprising;
a plurality of worker-servers each running a desktop operating system and each configured with high-performance graphics processing hardware, wherein each worker-server is executing only one desktop application that utilizes the high performance graphics hardware that generates rendered graphics frames with the high-performance graphics hardware, wherein each desktop operating system is configure to scrape and compress the rendered graphic frames, wherein each worker-server is in communication with a global network, and wherein the plurality of worker-servers are configured to send the rendered and compressed graphic frames to the global network;
a management-server wherein the management server is configured to select a first-set of worker-servers identifiers from the plurality of worker-servers identifiers based on a received application-identifier and a received client-identifier, wherein each of the worker-server identifiers within the set of worker-server identifiers is associated with a worker server not executing an application that is utilizing high-performance graphics processing hardware associated with each of the worker-servers, wherein the management-server is configured to communicate with the global network and is configured to send the first-set of worker-servers to the global network;
a client device configured to communicate the application-identifier and the client-identifier to the management-server and configured to receive the first-set of worker servers and communicate with the worker-server through the global network, and wherein the client device is configured to send a one or more broadband-pings to each first-set of worker-servers, and wherein the client device is configured to receive one or more broadband-echo response data streams from each of the first-set worker-servers, and wherein the client device measures a roundtrip transmission time for sending each of the one or more broadband-ping messages and receiving the associated one or more associated broadband-echo response data streams for each of the first-set of worker servers, and wherein the client device is configured to connect to a selected-worker-server from the first-set of worker-servers with a lowest cumulative roundtrip transmission times from the associated one or more broadband-ping messages; and
a database-server configured to communicate with and the plurality of worker-servers and configured to receive from and store the worker-servers application-persistent data associated with the client identifier and the application-identifier.

2. The system of claim 1 wherein the desktop application is a game and the operating system is configured to stream the game rendered graphics and audio to the client device.

3. The system of claim 2 wherein the desktop operating system is a Microsoft Windows desktop operating system, wherein the application persistent data is Windows registry variables, environment variables, files, or a combination thereof, wherein the registry variables are loaded into the Windows registry of the selected-worker-server.

4. The system of claim 3 wherein the desktop operating system is selected from the group consisting of Windows XP, Windows Vista, Windows 7, Windows 8, Windows 10, and Microsoft server.

5. The system of claim 3 wherein the broadband-echo data stream is greater than one megabyte in size.

6. The system of claim 5, wherein the one or more broadband-ping messages is three broadband-ping messages.

7. The system of claim 6, wherein the first-set of worker-server identifiers has at least three worker-server identifiers.

8. The system of claim 7 wherein the client-device has an operating system and wherein the client-device operating system is different than the worker-server operating system.

9. A method of client-device accessing a worker-server application from a plurality of worker-servers comprising the steps;
communicating from a client-device to a management-server an application-identifier and a client identifier to the management server over a global network;
determining by the management-server a first-set of worker-servers identifiers from a plurality of worker-servers identifiers, wherein each first-set worker-server identifier is associated with a worker-server that is not executing an application that is utilizing an associated worker-server high-performance graphics processing hardware;
sending from the management-server to the client device the first-set of worker-servers identifiers;
sending from the client-device to each of the first-set worker-servers associated with the first-set worker-servers identifiers one or more broadband-ping messages;
receiving by the client device each the one or more associated broadband-echo data streams from each of the first-set of worker-servers;
recording by the client time-intervals between sending each of the one or more broadband-ping messages and receiving each of the one or more associated broadband-echo data streams for each of the first-set worker-servers;
selecting by the client device a selected-worker-server identifier from first-set of worker-servers identifies with the lowest associated cumulative time intervals;
sending from the client-device to the selected-worker-server the client identifier and the application-identifier and an indication to start the associated application;
requesting by the selected-worker-server to a database server and receiving from the database server application-persistent data associated with the client-identifier and application-identifier; and
executing on the selected-worker-server the application associated with the application-identifier.

10. The method of claim 9, wherein the plurality of worker-servers are each configured with high performance graphics hardware having more than sixty-four graphic cores.

11. The method of claim 10 wherein the loading the desktop operating system is Windows desktop operating system and wherein the loading application persistent data are Windows registry variables associated with the client identifier and wherein the storing the current application persistent data associated with the client identifier are the application associated Windows registry variables, application files, or a combination thereof.

12. The method of claim 10 wherein the one or more broadband-echo data streams is greater than one-hundred Kbytes.

13. The method of claim 13 wherein the one or more broadband-ping messages is three or greater.

14. The method of claim 13 wherein there are at least three worker-server identifiers in the first set of worker servers identifiers.

15. The method of claim 14, wherein at least one worker-server associated with the first-set of worker server identifiers is located in a different physical facility than the other worker servers associated with the first set worker-server identifiers.

16. The method of claim 14 wherein the client-device has an operating system and wherein the client-device operating system is different than the worker-server operating system.
